(19) United States
(12) Patent Application Publication
(10) Pub. No.: US 2010/0263544 A1
(43) Pub. Date: Oct. 21, 2010

(54) SINGLE SERVE BEVERAGE MACHINE

(75) Inventors: Hermanus Joseph Kodden, Hoogeveen (NL); Taru Talvikki Hannikainen, Heerenveen (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/158,459

(22) PCT Filed: Dec. 15, 2006
(86) PCT No.: PCT/IB06/54884

§ 371 Date: Jun. 20, 2008

(30) Foreign Application Priority Data
Dec. 22, 2005 (EP) 05112744.7

(51) Int. Cl. A47J 31/44; F25B 21/00; F25C 5/18

(52) U.S. Cl. 99/288; 62/3.1; 62/344

(57) ABSTRACT

The present invention provides a single serve beverage machine for brewing beverages, comprising liquid supply means; a heater (18) for heating liquid; a brewing chamber (20) capable of receiving liquid and capable of accommodating ingredients in the form of single serve portions (22), wherein the ingredients are to he brewed or mixed with liquid in order to extract a beverage; and cooling means adapted for selectively cooling the beverage. This single serve beverage machine can produce iced beverages made based on freshly brewed concentrate.

The invention relates to a single serve beverage machine for brewing beverages, comprising liquid supply means, a heater for heating liquid and a brewing chamber capable of receiving liquid and capable of accommodating ingredients in the form of single serve portions, wherein the ingredients are to be brewed or mixed with liquid in order to extract a beverage.

Single serve beverage machines such as known from WO 2005/053485 A1 are getting more and more popular. In these single serve beverage machines, hot beverages, such as coffee, arc brewed with hot water. In difference to conventional brewing appliances, these single serve beverage machines are provided with a brewing chamber, which is adapted to accommodate ingredients in the form of single serve portions. In WO 2005/053485 A1 pads are used as single serve portions, which hold ingredients of a predetermined amount and are distributed in a ready-to-use form. In order to extract beverages using these pads the hot water is pressurized and fed through the porous shell of the pad. Due to the usage of pads, the extracted beverage is provided in an optimized concentration. The easy and fast handling as well as their compact size are the main reasons for the popularity of these single serve beverage machines.

It is therefore an object of the present invention to provide a single serve beverage machine with a broadened functionality without increasing the standing area considerably.

This object is solved by a single serve beverage machine according to claim 1. Further advantageous developments are outlined in the dependent claims.

In accordance with the invention there is provided a single serve beverage machine for brewing beverages, comprising liquid supply means; a heater for heating liquid; a brewing chamber capable of receiving liquid and capable of accommodating ingredients in the form of single serve portions, wherein the ingredients arc to be brewed or mixed with liquid in order to extract a beverage; and cooling means adapted for selectively cooling the beverage. The advantage of such a single serve beverage machine is that iced beverages can be made based on freshly brewed concentrate. In this context, single serve beverage is defined as a predefined quantity of beverage for one or more (preferably one or two) drinking vessels (such as cups or glasses) based on the use of pre-portioned ingredients in a pad, a capsule, a cup-like capsule or a pouch, or pre-portioned by the single serve beverage machine from bulk. Thus, in a single serve beverage machine the beverage is not provided in a pot from where it is poured into drinking vessels, but the single serve beverage machine begins to pour the beverage into all drinking vessels while the brewing or mixing process continues. The single serve portions are the corresponding ingredient portions used in these single serve beverage machines for brewing one or more (preferably one or two) drinking vessels of beverage. Moreover, the selective cooling of the cooling means indicates that the cooling means are provided in the single serve beverage machine, but that it is also possible to turn them off and to brew a hot beverage without cooling it.

According to the present invention it is preferred that the cooling means comprise an ice dispenser. The cooling of the extracted beverage by ice from an ice dispenser has the advantage, that the cooling can be used for diluting the extracted beverage, which is preferably a concentrate.

Moreover for the present invention it can be envisaged that the cooling means comprise an electric cooling device. Such an electric cooling device has the advantage that the beverage can be cooled without requiring any ice produced in a separate refrigerator.

A further development of the present invention is that the ice dispenser comprises an ice container for storing ice cubes to be mixed with the beverage. Thus, a space for storing ice for more than a single serving is provided.

Moreover it is preferred that the ice dispenser comprises cutting means for cutting the ice cubes into sliced ice to be mixed with the beverage. Due to the cutting means the sliced ice provides a greater surface area and therefore the ice is melted faster and cools the extracted beverage faster. Furthermore, a slush beverage can be made, which is a mixture of the beverage and sliced ice.

Furthermore it is preferred that the single serve beverage machine is adapted for mixing the extracted beverage and the ice dispensed from the ice dispenser within a drinking vessel not being part of the single serve beverage machine. Thus, the consumer can observe the mixing process and the iced beverage can be provided in a cup or glass ready to drink. No extra pot is required.

Further it is favorable that the cooling means comprise an electric cooling device which is positioned on the same vertical line as the brewing chamber. Due to this measure the single serve beverage machine can be small-sized and requires a small standing area.

Moreover it is favorable that wherein the liquid supply means is a liquid container and wherein the single serve beverage machine further comprises a pump for feeding liquid from the liquid container to the brewing chamber, wherein the cooling means comprise an electric cooling device and wherein electric driving means for driving the pump are also adapted for driving a compressor of the cooling device. Thus, the single serve beverage machine can be small-sized, since the same driving means drives two separate components.

It is favourable that the cooling means comprise an electric cooling device which is adapted for producing ice cubes or sliced ice. Thus, it is not required to produce the ice cubes in a separate refrigerator, but the ice cubes can be produced from liquid which is needed anyway for extracting the beverage from the ingredients.

It is further favourable that the ice container comprises insulation means for keeping the ice cubes cold. Thus, the ice cubes can be prevented from melting in the ice container for a longer period of time.

These and other aspects of the invention will be apparent from and elucidated with reference to the embodiments described herein after.

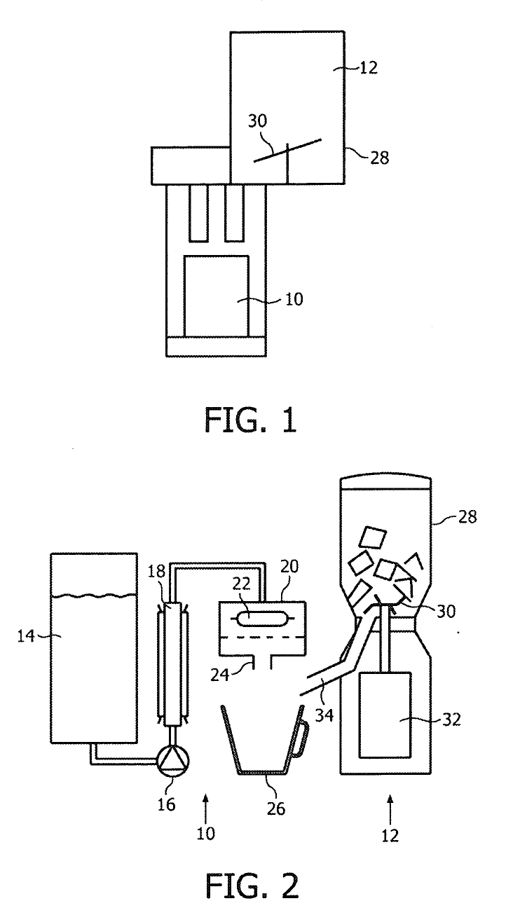

FIG. 1 shows a schematic diagram of a single serve beverage machine according to a first embodiment of the present invention.

FIG. 2 illustrates the single serve beverage machine according to the first embodiment of the present invention more detailed.

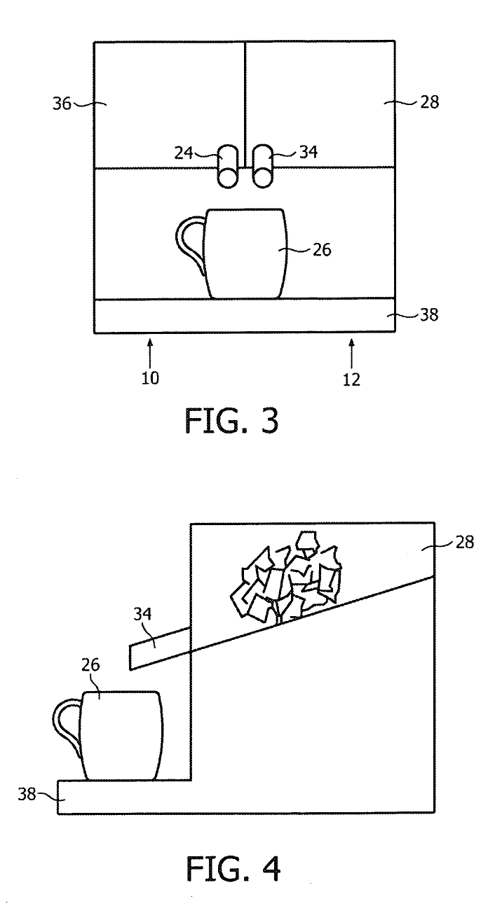

FIG. 3 shows a front view of an implementation of the single serve beverage machine of the first embodiment.

FIG. 4 shows a side view of the single serve beverage machine shown in FIG. 3.

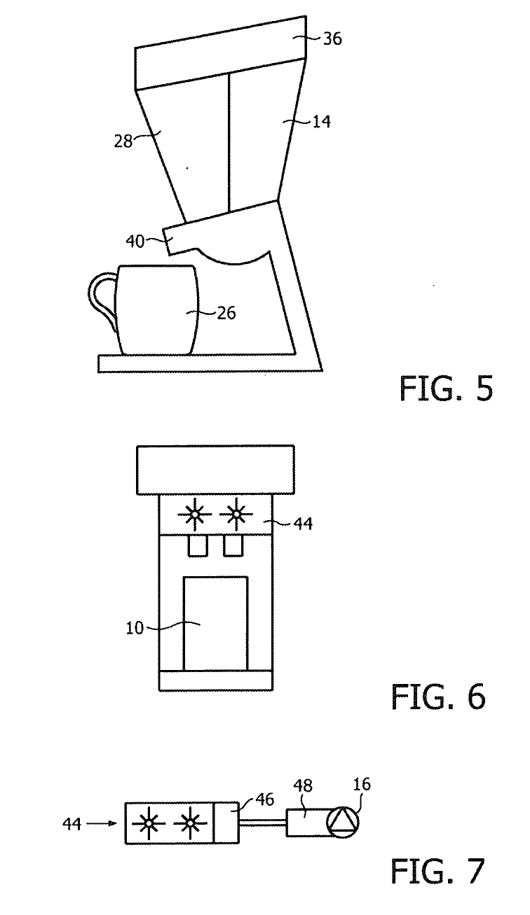

FIG. 5 shows another implementation of the single serve beverage machine of a modification of the first embodiment of the present invention.

FIG. 6 shows a schematic diagram of a single serve beverage machine according to a second embodiment of the present invention.

FIG. 7 shows a schematic diagram of a cooling device of the second embodiment of the present invention.

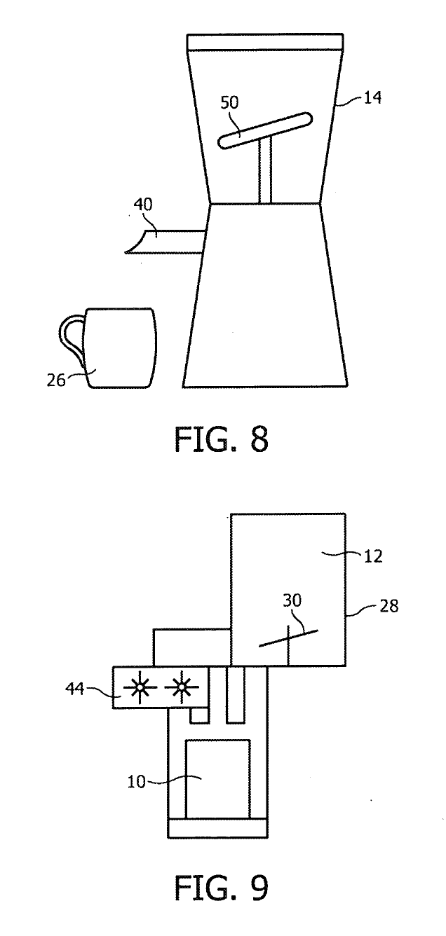

FIG. 8 shows an implementation of the single serve beverage machine of the second embodiment.

FIG. 9 shows a schematic diagram of a single serve beverage machine according to a third embodiment of the present invention.

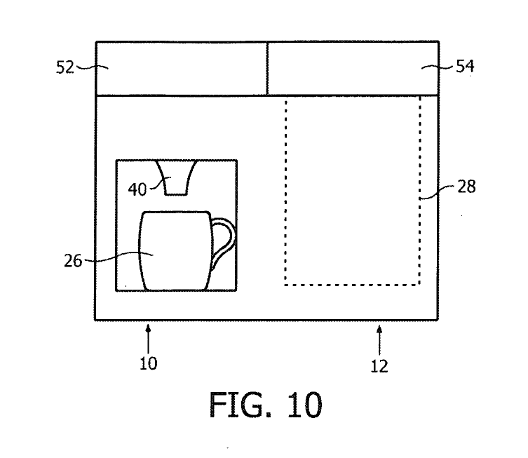

FIG. 10 shows an implementation of the single serve beverage machine of the third embodiment.

FIG. 1 shows a schematic diagram of a single serve beverage machine according to a first embodiment of the present invention. This single serve beverage machine comprises basically a brewing device 10 for preparing beverages, such as coffee, tea or hot chocolate, by brewing or mixing ingredients to be brewed with a liquid which is preferably hot water. The extracted beverage is preferably provided in a concentrated form otherwise the finished beverage would be diluted too much when mixed with ice cubes. In the present invention, these ingredients are provided in the form of single serve portions, such as pads, capsules, cup-like capsule or pouches. Moreover, these single serve portions can be ingredient-portions which are pre-portioned by the single serve beverage machine from bulk. For example, the pads can be bought in a ready-to-use form comprising a porous closed shell being substantially disc-shaped and filled with ingredients to be brewed. Additionally to the above function, the brewing device 10 may be adapted to extract a concentrated beverage by diluting or dissolving prefabricated concentrate in pre-packed portions or in bulk. A further additional function of the brewing device 10 may be to just convey and dispense prefabricated liquid concentrate without diluting it with liquid. Further to the brewing device 10, the beverage preparation machine comprises an ice dispenser 12 for providing ice cubes or sliced ice. In this embodiment the ice cubes are produced in a separate refrigerator and are stored in the ice dispenser 12.

FIG. 2 illustrates the single serve beverage machine according to the first embodiment of the present invention more detailed. The brewing device 10 comprises a liquid container 14 as liquid supply means for storing a liquid which is usually water, but it can also be water containing some additives. Alternatively to the liquid container 14, the liquid could be directly fed to the brewing device 10 via a direct water supply connection as liquid supply means. Further, the brewing device 10 comprises a pump 16 for pumping and/or pressurizing the liquid, a heater 18 for heating the liquid and a brewing chamber 20 arranged in this order starting from the liquid container 14, wherein each of these components is in communication with the preceding and succeeding component such that the liquid is enabled to flow upon request from the liquid container 14 via the pump 16 and the heater 18 to the brewing chamber 20. Within the brewing chamber 20, the single serve portion 22 can be arranged, which contains the ingredients to be brewed. While/after brewing the ingredients within the brewing chamber 20, the extracted beverage is discharged from the brewing chamber 20 via a dispenser nozzle 24 and poured directly into a drinking vessel 26, such as a glass or cup. The brewing chamber 20 is adapted for holding the single serve portion 22 accordingly. This adaptation includes the provision of supporting means adaptable to the different shaped and sized single serve portions 22 available on the market. Further, the adaptation includes that the brewing chamber 22 has to be constructed such as to withstand the high pressure of the liquid, which is pressurized by the pump 16. This means further that the brewing chamber 20 has to be openable for removing the used single serve portion 22 and/or inserting a new single serve portion 22. Moreover, the brewing chamber 20 has to be strong enough and sealed such that the pressurized liquid is exclusively discharged via the dispenser nozzle 24 after passing through the single serve portion 22. Further to the brewing device 10, the single serve beverage machine comprises the ice dispenser 12 having an ice container 28 for storing ice cubes which are produced in this embodiment in a separate refrigerator. The ice container 28 is coated on its inner side with a thermal insulation layer as insulation means for keeping the ice cubes cold. The ice dispenser 12 further comprises cutting means 30 for cutting and/or shaving the ice cubes into sliced ice. The cutting means 30 are arranged inside the ice container 28 near the bottom of the ice container 28 and can be implemented by a rotating blade or blades, which can be inclined relative to the horizontal direction. The cutting means 30 can be rotated by an electric motor 32 being coupled to the cutting means 32 via a shaft. Alternatively, to the separate electric motor 32, electrical driving means for driving the pump 16 of the brewing device 10 can be adapted such that they also drive the cutting means 30. This way, a more compact size of the single serve beverage machine can be achieved. From the ice container 28 an ice dispenser nozzle 34 leads to a position in the vicinity of the dispenser nozzle 24 of the brewing device 10.

While a beverage is brewed or mixed in the brewing device 10, the ice cubes are cut into sliced ice by the cutting means 30 which are driven by the electric motor 32. The cutting means 30 are formed such that additionally to cutting they convey the sliced ice to the dispenser nozzle 34 such that it is guided into the drinking vessel 26. For feeding a predetermined amount of sliced ice to the drinking vessel 26, the cutting means 30 are driven for a predetermined time period. Alternatively, there may be provided additional closing means for closing the dispenser nozzle 34 or conveying means for dispensing the optimal amount of sliced ice. The extracted beverage is then poured from the dispenser nozzle 24 into the drinking vessel 26 where it mixes with the sliced ice. This way the sliced ice cools the extracted beverage (which is preferably hot and concentrated) to an iced beverage while the sliced ice melts. With an overdose of sliced ice a slush beverage can be made. Thereby, the brewing device 10 brews a hot beverage according to the following process. The pump 16 sucks the liquid from the liquid container 14, pressurizes it and conveys it through the heater 18, where the liquid is heated. From there, the liquid is further conveyed to the brewing chamber 20, where the hot pressurized liquid is passed through the single serve portion 22.

In order to determine the amount of ice required, the inventors of the present invention conducted experiments using coffee and ice cubes made of water. In order to cool the coffee from the starting point of about 75° C. to below 10° C., the amount of ice has to be equal to the amount of coffee. Thus, for 60 g of fresh brewed hot coffee 60 g of sliced ice is needed. This weight ratio does not yet leave any ice slush in the drink, but adding another portion of ice does. So adding for example another 60 g of sliced ice makes the beverage relatively slushy. The results from adding various amounts of ice to the hot coffee are summarized in the following table:

| | Amount of | Amount of | |
|---|---|---|---|
| Formula | coffee | ice | Result |
| m_{sliced ice} = 0.5 * m_{coffee} | 120 g | 60 g | All ice melted, |
| | | | beverage not cool |
| | | | enough |
| m_{sliced ice} = m_{coffee} | 60 g | 60 g | All ice melted and the |
| | | | beverage was well |
| | | | cooled |
| m_{sliced ice} = 2 * m_{coffee} | 60 g | 120 g | The beverage is slushy |
| m_{sliced ice} = 3 * m_{coffee} | 60 g | 180 g | The beverage is very |
| | | | slushy |

Thus, under consideration of the above results, the preferred weight ratio is the one that provides a shush beverage. However, the beverage preparation machine can comprise adjusting means giving the end-user the possibility to select the mixing ratio, or the mixing ratio can be selected by a controller automatically depending on the used ingredients or depending on the concentration of the extracted beverage (e.g. in the case of coffee, if the coffee is very strong). As already mentioned above, the extracted beverage is preferably brewed such that it is derived in a concentrated form, since otherwise the amount of liquid would be too high after the sliced ice is melted.

FIG. 3 shows a front view of an implementation of the single serve beverage machine of the first embodiment. In this single serve beverage machine the ice dispenser 12 is provided next to the brewing device 10. On the upper end of the single serve beverage machine the ice container 28 is arranged beside a coffee-part 36 comprising some elements of the brewing device 10. The brewing device 10 extracts beverages in the above described manner, wherein the brewing chamber 20 is accessably arranged within the coffee-part 36. A base plate 38 is attached to the lower end of the single serve beverage machine for placing the drinking vessel 26. The extracted beverage is poured into the drinking vessel 26 via the dispenser nozzle 24 and the sliced ice is supplied to the drinking vessel 26 via the dispenser nozzle 34.

FIG. 4 shows a side view of the single serve beverage machine shown in FIG. 3. The bottom of the ice container 28 is inclined towards the dispenser nozzle 34. This way the inclined bottom acts as conveying means such that the sliced ice or the ice cubes slide along the inclined bottom. Thus, the sliced ice or the ice cubes can easily discharged from the ice container 28. Inside the ice container 28, the cutting means 30 are provided as described in connection with FIG. 2.

FIG. 5 shows another implementation of the single serve beverage machine of a modification of the first embodiment of the present invention. In this single serve beverage machine the extracted beverage is mixed with the sliced ice within the single serve beverage machine. The top part forms the coffee part 36, which is a part of the brewing device 10 such that the extracted beverage flows through the ice container 28. The mixture leaves the single serve beverage machine via a common dispenser nozzle 40.

FIG. 6 shows a schematic diagram of a single serve beverage machine according to a second embodiment of the present invention. This single serve beverage machine comprises a brewing device 10 constructed as in the first embodiment and a cooling device 44 which is preferably electrical. The cooling device 44 is arranged on the same vertical line as the brewing device 10. The beverage which is extracted using the brewing device 10 is guided through the cooling device 44 which lowers the temperature of the beverage. Thereafter, the cooled beverage is lead to the drinking vessel 26 and is ready for consumption.

FIG. 7 shows a schematic diagram of the cooling device 44 of the second embodiment of the present invention. The electrical cooling device 44 may comprise a compressor 46, wherein the electric driving means 48 for driving the pump 16 of the brewing device 10 arc adapted for also driving the compressor 46 of the cooling device 44.

FIG. 8 shows an implementation of the single serve beverage machine of the second embodiment. In this single serve beverage machine, liquid within the liquid container 14 is cooled down to ice-liquid. The beverage which is extracted using the brewing device 10 is mixed with the ice-liquid within the single serve beverage machine and lead to a common dispenser nozzle 40. Moreover, agitation means 50 are provided for agitating the ice-liquid. This way, a smooth and even cooling of the ice-liquid can be ensured.

FIG. 9 shows a schematic diagram of a single serve beverage machine according to a third embodiment of the present invention. This single serve beverage machine comprises a brewing device 10 as described in the first embodiment, an ice dispenser 12 as described in the first embodiment and a cooling device 44 as described in the second embodiment. The cooling device 44 can be used for cooling the extracted beverage by guiding the beverage through the cooling device 44 and/or can be used for producing ice cubes which are then stored in the ice container 28. Moreover, the electric cooling means can be used for producing sliced ice by cooling a wall on which ice is formed and scraped away by a scraper. In a preferred form of the third embodiment, the cooling device 44 cools the extracted beverage before it is mixed with the ice from the ice dispenser 12. After going through the cooling system, the extracted beverage lands in the drinking vessel 26 together with the ice from the ice dispenser 12. The pre-cooled extracted beverage and the ice mix with each other in the drinking vessel 26.

FIG. 10 shows an implementation of the single serve beverage machine of the third embodiment. In this single serve beverage machine the brewing device 10 is arranged next the ice dispenser 12. The ice dispenser 12 holds ice cubes produced in a refrigerator within the ice container 28. The electric cooling device 44 keeps the ice cubes stored in the ice container 28 cool. The top part of the single serve beverage machine forms two hinged covers 52, 54 next to each other, wherein the hinged cover 52 provides access to the brewing chamber 20 of the brewing device 10, whereas the hinged cover 52 provides access to the ice container 28 of the ice dispenser 12. The beverage which is extracted using the brewing device 10 is mixed with the ice dispensed from the ice dispenser 12 and dispensed from the common dispenser nozzle 40.

The above described invention thus provides the advantage, that the functionality of the single serve beverage machine is broadened beyond the conventional functionality of making hot coffee or hot tea. Thus, iced beverages or slush beverages, such as iced coffee or iced tea can be produced.

Equivalents and modifications not described above may also be employed without departing from the scope of the invention as defined in the accompanying claims.

For example, the single serve beverage machine may also be provided with reservoirs for additives like sugar, milkpowder or syrups.

In the accompanying claims reference numerals are provided exclusively for an easier understanding of the claims. It is not intended in any way that these reference numerals shall limit the scope of the invention.

1. A single serve beverage machine for brewing beverages, comprising:
a liquid supply means;
a heater (18) for heating liquid;
a brewing chamber (20) capable of receiving liquid and capable of accommodating ingredients in the form of single serve portions (22), wherein the ingredients arc to be brewed or mixed with liquid in order to extract a beverage;
characterized by cooling means adapted for selectively cooling the beverage.

2. The single serve beverage machine according to claim 1, wherein the cooling means comprise an ice dispenser (12).

3. The single serve beverage machine according to claim 1 or 2, wherein the cooling means comprise an electric cooling device (44).

4. The single serve beverage machine according to claim 2, wherein the ice dispenser (12) comprises an ice container (28) for storing ice cubes to be mixed with the beverage.

5. The single serve beverage machine according to claim 4, wherein the ice dispenser (12) comprises cutting means (30) for cutting the ice cubes into sliced ice to be mixed with the beverage.

6. The single serve beverage machine according to claim 2, wherein the single serve beverage machine is adapted for mixing the extracted beverage and the ice dispensed from the ice dispenser (12) within a drinking vessel (26) not being part of the single serve beverage machine.

7. The single serve beverage machine according to claim 1 or 2, wherein the cooling means comprise an electric cooling device (44) which is positioned on the same vertical line as the brewing chamber (20).

8. The single serve beverage machine according to claim 1 or 2, wherein the liquid supply means is a liquid container (12) and wherein the single serve beverage machine further comprises a pump (16) for feeding liquid from the liquid container (12) to the brewing chamber (20), wherein the cooling means comprise an electric cooling device (44) and wherein electric driving means (48) for driving the pump (16) are also adapted for driving a compressor (46) of the cooling device (44).

9. The single serve beverage machine according to claim 1 or 2, wherein the cooling means comprise an electric cooling device (44) which is adapted for producing ice cubes or sliced ice.

10. The single serve beverage machine according to claim 4, wherein the ice container (28) comprises insulation means for keeping the ice cubes cold.
